(19) United States
(12) Patent Application Publication
(10) Pub. No.: US 2003/0014470 A1
(43) Pub. Date: Jan. 16, 2003

(54) Electronic equipment, electronic unit, and processing method of version compatibility verification between units

(75) Inventor: Koichi Iijima, Kawasaki (JP)

Correspondence Address: ARMSTRONG,WESTERMAN & HATTORI, LLP, 1725 K STREET, NW., SUITE 1000, WASHINGTON, DC, 20006, US

(73) Assignee: Fujitsu Limited, Kawasaki (JP)

(21) Appl. No.: 10/017,299

(22) Filed: Dec. 18, 2001

(30) Foreign Application Priority Data
Jul. 13, 2001 (JP) 2001-213745

(51) Int. Cl. G06F 9/00

(52) U.S. Cl. 709/106

(57) ABSTRACT

Electronic equipment has a plurality of electronic units working in cooperation and verifies the compatibility between entire electronic units having different version data. A first electronic unit has a first version data of the first electronic unit itself and a first support version data of the opposite (second) electronic unit being supported by the first electronic unit. A second electronic unit has a second version data of the electronic unit itself, and a second support version data of the opposite (first) electronic unit being supported by the second electronic unit. Either one electronic unit verifies the compatibility between the plurality of electronic units by comparing the first version data with the second support version data, and also by comparing the second version data with the first support version data.

### BACKGROUND OF THE INVENTION

1. Field of the Invention

The present invention relates to an electronic equipment mounted a plurality of electronic units and more particularly to an electronic equipment, an electronic unit and a processing method of automatic version compatibility verification for verifying version compatibility between a plurality of electronic units.

2. Description of the Related Art

Today, in most electronic equipment including computers, peripheral equipment and home appliances, there is provided a controller having electronic circuits structured on a unit (or board) basis. Control program is loaded in such a controller. For example, a printer includes a mechanism controller unit for controlling a printer engine, and a controller unit for processing the information received from a host.

In these controller units, processing circuits including a processor such as a CPU are mounted. In a mechanism controller, a control program is provided for controlling the engine. Also in a controller, another control program is provided for controlling the information received from the host.

Configuring controllers with a plurality of units produces such advantages as described below:

(1) Production cost can be reduced by manufacturing equipment on a unit by unit basis.

(2) Control program developed on a unit basis also leads to cost reduction.

(3) Repairs can easily be taken against an equipment failure in operation by substituting either a failed unit or a defective control program of a unit.

(4) Partial function upgrading can easily be done by substituting a related unit or a control program.

Meanwhile, when substituting a unit independently from others in electronic equipment constituted by such a plurality of units, there may be a case that the normal operation of the equipment becomes prevented if the newly substituted unit has a different (either newer or older) version from the unit version previously used. This occurs a case that operation of a new unit having different version with other existing units is not guaranteed.

In case of substituting a control program in a unit, the above case is also probable when the compatibility of the unit with other units becomes prevented after the substitution without restriction.

In order to eliminate such inconvenience, for example in the official gazette of Japanese Unexamined Patent Publication No. 2000-259398, there is disclosed a method for deciding whether the version of a module (unit) being either substituted or newly added coincides with the version specified in the system in which the module (unit) is embedded. Further, it is also disclosed that in case the compatibility cannot be satisfied, a program compatible with the system is newly introduced from management equipment to maintain the compatibility.

There are often cases in actual fields that a variety of versions exist for control programs and units, some of which are compatible with other different versions. According to this conventional method of deciding compatibility using the coincidence of the versions, it is decided there is no compatibility unless the version exactly coincides with the required version. Accordingly, there is a problem that even a module being compatible results in a decision of being incompatible because of having an unmatched version, and therefore the module cannot be applied.

Moreover, according to the conventional method, because the compatibility decision is performed by management equipment, it is not possible to decide the compatibility within the module (unit) to be substituted. Therefore the method cannot be applied unless the module the management equipment is dedicatedly provided.

Furthermore, in the conventional method, it is required to replace an entire control program when incompatibility is detected, and any part of the control program having been installed becomes not available any further.

### SUMMARY OF THE INVENTION

Accordingly, it is an object of the present invention to provide electronic equipment, an electronic unit, and a processing method of compatibility verification for verifying the compatibility between the units having different versions.

It is another object of the present invention to provide electronic equipment, an electronic unit and a processing method of compatibility verification for maintaining the compatibility by changing a version of a unit having a different version on detection of the incompatibility.

In order to attain the aforementioned objects, according to the present invention, electronic equipment having a plurality of electronic units comprises a first electronic unit having a first version data of the first electronic unit itself, and a first support version data of the opposite second electronic unit being supported by the first electronic unit; and a second electronic unit having a second version data of the second electronic unit itself, and a second support version data of the opposite first electronic unit being supported by the second electronic unit. At least either of the first electronic unit or the second electronic unit verifies the compatibility between the plurality of electronic units by judging large and small relationship of the first version data and the second support version data, and also by judging large and small relationship the second version data and the first support version data.

Further, the electronic unit according to the present invention has compatibility verification data which comprises; a support version data of the opposite electronic unit supported by the electronic unit itself, to be judged large and small relationship with a version data of the opposite electronic unit; and a version data of the electronic unit itself being supported by the opposite electronic unit.

Still further, according to the present invention, a method of the compatibility verification in electronic equipment comprises the steps of; evaluating version data magnitude of the electronic units by comparing a first version data of one electronic unit among the plurality of electronic units with a support version data of the electronic unit supported by the other electronic unit; evaluating version data magnitude of the electronic units by comparing second version data of the other electronic unit with a support version data of the other electronic unit supported by the electronic unit; and verifying the compatibility among the plurality of electronic units using the both evaluation results.

According to the present invention, there are provided in each unit by unit the own version data and the support version data of the opposite side (the other unit). These version data of the units are checked each other in either one unit. Therefore, when one unit fails and a unit having a newer (or older) version is incorrectly substituted for the failed unit, thus producing incompatible, the compatibility verification can be carried out automatically between any combinations of the units having different versions.

Still further, according to the present invention, preferably each support version data of the first electronic unit or the second electronic unit supported by the other unit comprises the most up-to-date version supported by each electronic unit. Accordingly the compatibility can be verified simply by comparing the magnitude of version data.

Still further, according to the present invention, preferably each plurality of electronic units has a memory for storing control program, and a processor for executing the control program. In addition, the version data comprises a version data of the control program. This enables easy compatibility verification and thus updating control program versions becomes simple.

Still further, according to the present invention, preferably either one electronic unit verifies the compatibility after either one electronic unit of the first electronic unit or the second electronic unit is substituted. Accordingly, the compatibility of the electronic units can be guaranteed when unit substitution is carried out on site.

Still further, according to the present invention, when either one electronic unit decides the incompatibility by the compatibility verification, preferably the electronic unit changes the version of the control program version so as to maintain the compatibility between both control program. Accordingly, the control program can be proceeded to an optimal version.

Still further, according to the present invention, either one electronic unit preferably changes the version of the control program comprised an old control program and its differential information by controlling the differential information to make either valid or invalid. Accordingly, the control program can be proceeded to an optimal version by using the differential information of the control program.

Still further, according to the present invention, preferably the plurality of electronic units are constituted by printer control units.

Still further, according to the present invention, preferably each plurality of electronic units has a memory for storing control program and a processor for executing said control program, and said either one electronic unit verifies the compatibility using the version data of the control programs after changing either of the control program version, so as to maintain the compatibility between said control programs. Thus, using the compatibility verification, the control program can be proceeded to an optimal version.

Still further, according to the present invention, preferably the compatibility verification is carried out when the control program is installed to either one electronic unit of the plurality of electronic units. Accordingly, the compatibility is verified before installing the control program from external equipment, thus preventing the installation of an invalid control program.

Further scopes and features of the present invention will become more apparent by the following description of the embodiments with the accompanied drawings.

### BRIEF DESCRIPTION OF THE DRAWINGS

FIG. 1 shows a configuration diagram of electronic equipment according to an embodiment of the present invention.

FIG. 2 shows an explanation on a version data of one controller and a support version data of the opposite controller shown in FIG. 1.

FIG. 3 shows a flowchart of a compatibility verification processing according to a first embodiment of the present invention.

FIG. 4 shows an explanation drawing of the first embodiment of the present invention shown in FIG. 3.

FIG. 5 shows an explanation drawing of a compatibility verification processing according to a second embodiment of the present invention.

FIG. 6 shows an explanation drawing of the version data of one controller and the support version data of the opposite controller according to a third embodiment of the present invention.

FIG. 7A and 7B show explanation drawings of a compatibility verification processing according to the third embodiment of the present invention.

FIG. 8 shows a flowchart of the compatibility verification processing according to the third embodiment of the present invention.

FIG. 9 shows an explanation drawing of a typical example of the compatibility verification processing according to the third embodiment of the present invention.

FIG. 10 shows a flowchart of a compatibility verification processing according to a fourth embodiment of the present invention.

FIG. 11 shows a flowchart of an automatic version change processing in case the incompatibility is detected according to the embodiment shown in FIG. 10.

FIG. 12 shows a flowchart of a version data acquisition processing shown in FIG. 10.

FIG. 13 shows a flowchart of the compatibility verification processing shown in FIG. 10.

FIG. 14 shows a flowchart of a version data acquisition processing and a version upgrading/downgrading verification processing in the automatic version change processing in case of the incompatibility detection shown in FIG. 11.

FIG. 15 shows a flowchart of the compatibility verification processing and a version downgrading processing in the automatic version change processing in case of the incompatibility detection shown in FIG. 11.

FIG. 16 shows an operational diagram of the controller version downgrading processing shown in FIG. 15.

FIG. 17 shows an explanation drawing of the controller version downgrading processing shown in FIG. 16.

FIG. 18 shows a flowchart of the controller version downgrading processing shown in FIG. 15.

FIG. 19 shows an operational diagram of the controller version upgrading processing shown in FIG. 15.

FIG. 20 shows a flowchart of the controller version upgrading processing shown in FIG. 19.

### DETAILED DESCRIPTION OF THE PREFERRED EMBODIMENTS

The preferred embodiments of the present invention are described hereinafter in order of electronic equipment, compatibility verification method, compatibility verification processing and other embodiments referring to the charts and drawings.

[Electronic Equipment]

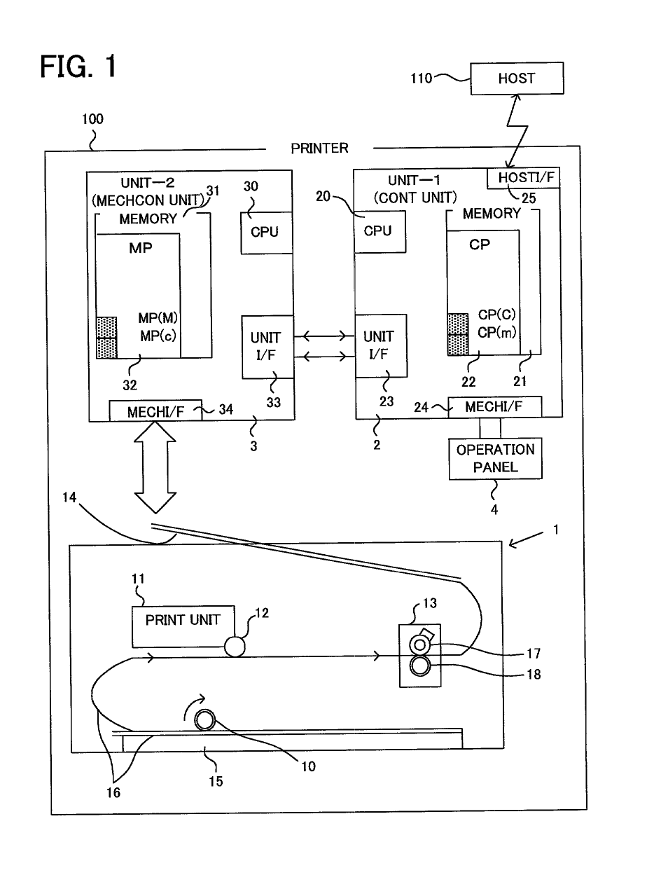

In FIG. 1, there is shown an embodiment of electronic equipment according to the present invention, in which a printer is taken as an example of electronic equipment.

As shown in FIG. 1, printer 100 includes a controller unit 2, a mechanism controller unit 3, a printer engine 1 and an operational panel 4. The mechanism controller unit 3 receives control commands and data (print orders and print data) from the controller unit 2 to control the printer engine 1. The controller unit 2 generates the control commands and data according to an instruction received from host 110 and the operational panel 4, and transmits to the mechanism controller unit 3.

The printer engine 1 is constituted by an electrophotographic mechanism. More specifically, the printer engine 1 includes a print unit 11 having a photosensitive drum 12, a heat roller fixer unit 13, a paper feed tray 15, a paper feed roller 10, and a stacker 14. By means of a known electrophotographic method, the print unit 11 exposes print information onto the photosensitive drum 12, produces an electrostatic latent image thereupon, develops the image to produce a toner image using a developer unit, and transfers the developed image on the photosensitive drum 12 to a sheet 16.

After the sheet 16 in the paper feed tray 15 is picked up by the paper feed roller 10 and is carried to the print unit 11, the toner image is transferred to the sheet 16. The transferred toner image on the sheet 16 is then heat-fixed by the heat fixer unit 13. The sheet 16 is then ejected to the stacker 14. The heat fixer unit 13 supplies heat energy onto the sheet 16 to resolve the toner image to make a fixture on the sheet 16, while carrying sheet 16, on which the toner image is formed, by sandwiching the sheet 16 with a heat roller 17 and a backup roller 18.

Such operation of the printer engine 1 is controlled by the mechanism controller 3. In this printer 100, the controller is constituted by the controller unit 2 (unit-1) and the mechanism controller unit 3 (unit-2) each structured on a separate board (printed board).

The controller unit 2 includes a CPU (processor) 20, a memory 21, an interface unit 23 to the mechanism controller unit 3, an interface unit 24 to the operation panel 4, and an interface unit 25 to the host 110.

Meanwhile, the mechanism controller unit 3 includes a CPU (processor) 30, a memory 32, an interface unit 33 to the controller unit 2, an interface unit 34 to the printer engine 1.

A control program (CP) 22 is installed in the memory 21 of the controller unit 2, while another control program (MP) 32 is installed in the memory 31 of the mechanism controller unit 3. Each interface unit 23, 33 is an interface unit which can communicate bi-directionally between the controller unit 2 and the mechanism controller unit 3.

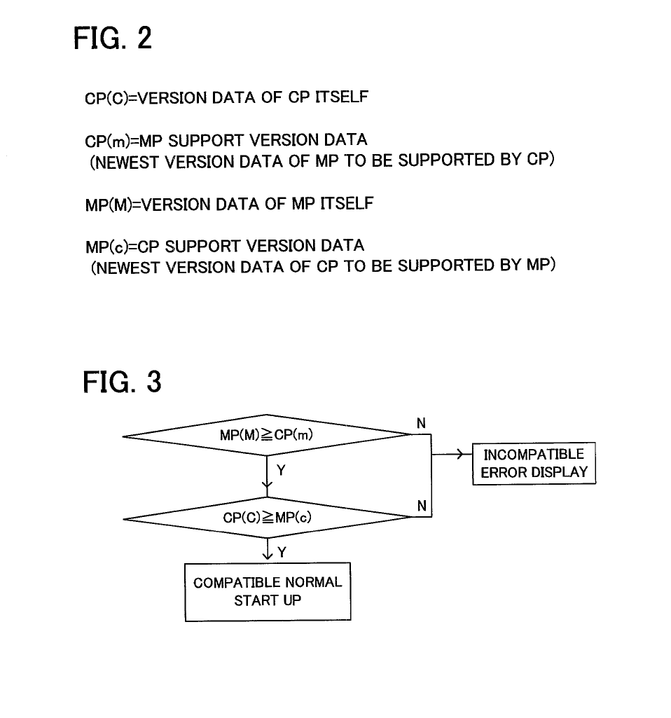

As shown in FIG. 1, the control program (CP) 22 provides version data CP (C) and CP (m), and the control program (MP) 32 provides version data MP (M) and MP (c). Referring to FIG. 2, the above version data to be used for verifying the compatibility between the control programs CP and MP is explained below. In the control program (CP) 22, the version data of the CP itself, which is referred to as a CP version data, CP (C), is provided, which is set a value ‘CVCL’. Also in the control program (CP) 22, the version data of the MP (opposite to the CP) supported by the CP, which is referred to as an MP support version data, CP (m), is provided, which is set a value ‘mvml’. Now, the compatibility of the two control programs (CP and MP) are verified in the following manner. In the description below, it is assumed that a larger version data denotes a newer version. The support version data ‘mvml’ is defined so that the control program (cp) 22 has an adjustment (supportability) program (CP) 22 and with the control program (MP) 32, if the current MP 32 has a version data not smaller than ‘mvml’.

Similarly, in the control program (MP) 32, version data of the MP itself, which is referred to as an MP version data, MP (M), is provided, which is set a value ‘MVML’. Also, in the control program (MP) 32, the version data of the CP (opposite to the MP) supported by the MP, which is referred to as a CP support version data, MP (c), is provided, which is set a value ‘cvcl’. The compatibility of the two control programs are verified in the following manner. It is also assumed that a larger version data denotes a newer version, if the current CP 22 has the version data not smaller than ‘cvcl’, the support version data ‘cvcl’ is defined so that the mechanism control program (MP) 32 has an adjustment (supportability) with the control program (CP) 22.

Using such version data specified above, the compatibility verification and the compatibility processing are carried out. The details of the processing will be explained later. In the aforementioned description, a printer is taken as the example of electronic equipment. However, it is also possible to apply to other electronic equipment such as a photocopier, peripheral equipment, computer and home appliance.

[Compatibility Verification]

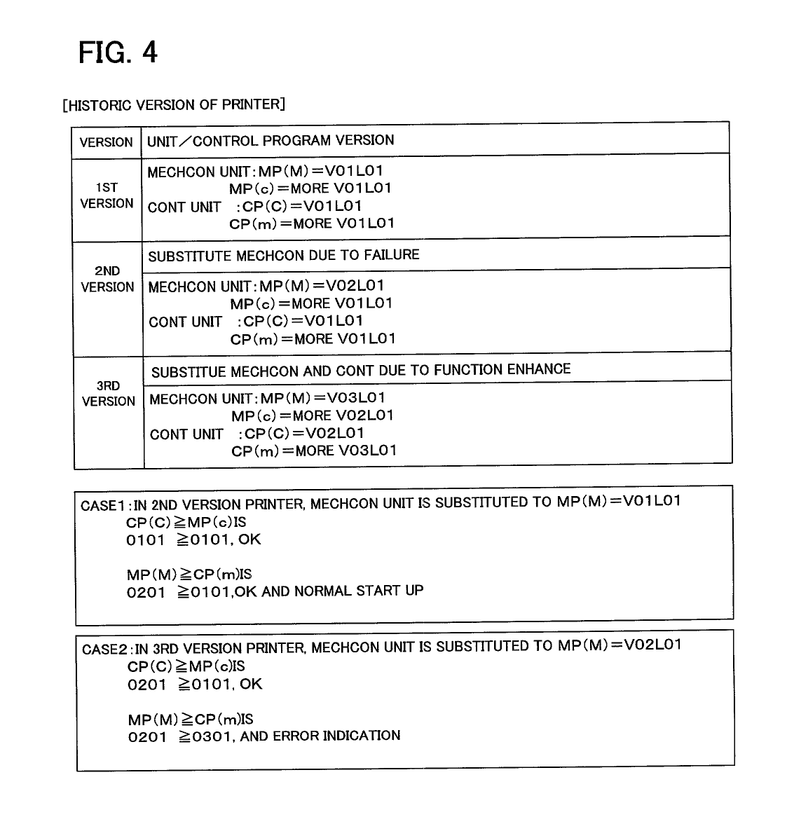

In FIG. 3, there is shown a flowchart of the compatibility verification processing in accordance with a first embodiment of the present invention. FIG. 4 shows an explanation drawing.

In FIG. 3, after the controller unit 2 or the mechanism controller unit 3 is substituted, the compatibility between the control programs 22 and 32 is verified when these control programs 22, 32 are started up. More specifically, the control program (CP) 22 in the controller unit 2 acquires the version data MP (M) and MP (c) recorded in control program (MP) 32 of the mechanism controller unit 3. The control program (CP) 22 in the controller unit 2 then compares the own MP support version data CP (m) with the MP version data MP (M) acquired above. If MP (M) is not larger than CP (m), the control program (CP) 22 decides that the MP is incompatible with the CP, and displays an error indication onto the operation panel 4. In other words, when the version of the control program (MP) 32 is older than the version which can be supported by the control program (CP) 22, it is decided that there is no compatibility, resulting in an error indication.

Similarly, the control program (CP) 22 in the controller unit 2 compares the own CP version data CP (C) with the MP support version data MP (c) acquired above. If CP (C) is not larger than MP (c), the control program (CP) 22 decides that the CP is incompatible with the MP, and displays an error indication onto the operation panel 4. In other words, when the version of the control program (CP) 22 is older than the version which can be supported by the control program (MP) 32, it is decided that there is no compatibility, resulting in an error indication.

Otherwise, the above mentioned acquisition and verification may be carried out in the control program (MP) 32 in the mechanism controller unit 3. When the verification results in the existence of compatibility, it denotes that each control program has a version data which the other control program expects. Accordingly, the control programs are started up normally. On the other hand, when the verification results in incompatibility, it denotes that at least one control program is not a control program of larger version than the version which the other control program expects. Accordingly an error indicating the incompatibility is displayed.

The above example illustrates the case of two units. The above method can be applied further in case of more than three units. Namely, by adding support version data for other units, it becomes possible to verify compatibility for more than three control programs.

Referring to FIG. 4, a more specific example is explained. In FIG. 4, it is assumed there exist printers having different three kinds of versions, namely a first version, a second version and a third version. Here, the second version includes the mechanism controller unit 3 having a version of ‘V02L01’ upgraded from the first version having a version of ‘V01L01’. Also, the third version includes controller unit 2 having a version of ‘V02L01’ upgraded from the second version of ‘V01L01’, and the mechanism the controller unit 3 having a version of ‘V03L01’ from the second version of the mechanism controller unit 3 of ‘V02L01’.

In case 1, there is shown a case that the mechanism controller 3 is substituted to the version MP (M)=V01L01 in a printer having the second version. When performing the comparison shown in FIG. 3, CP (C)=0101≧MP (c)=0101, which satisfies the compatibility. Also MP (M)=0201≧CP (m)=0101, which also satisfies the compatibility. Accordingly the control programs are started up normally.

In case 2, there is shown a case that the mechanism controller 3 is substituted to the version MP (M)=‘V02L01’ in a printer having the third version. When performing the comparison shown in FIG. 3, CP (C)=0201≧MP (c)=0201, which satisfies the compatibility. However, the relation MP (M)=0201≧CP (m)=0301 is not satisfied. Accordingly the compatibility is not satisfied and an error is displayed.

As explained above, by mutually storing version data of the other units that can be supported by the unit as well as the version data of the unit itself, it becomes possible to verify the compatibility between the units having different version data, which was not possible in the conventional method.

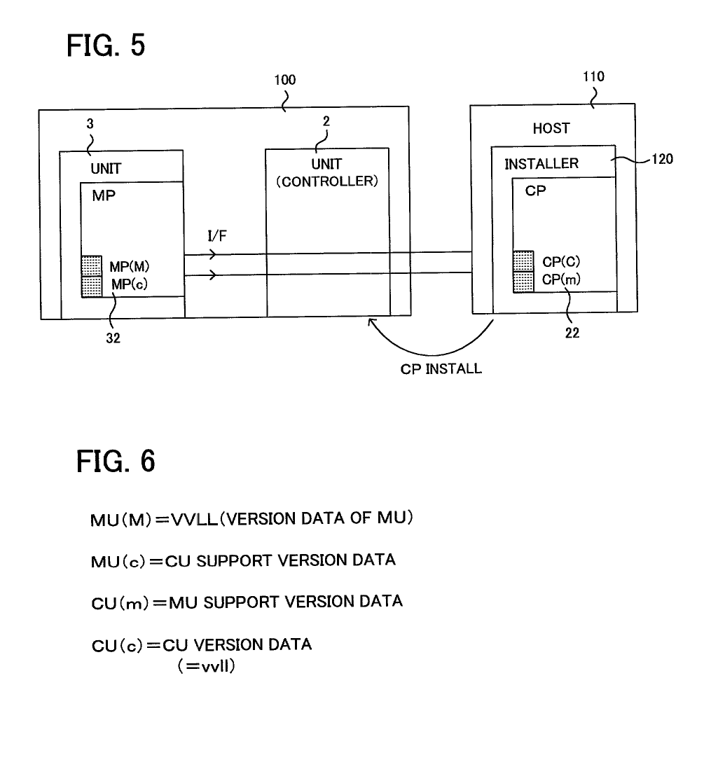

In FIG. 5, there is shown an explanation drawing of a compatibility verification method according to the second embodiment of the present invention. In this embodiment, the method of compatibility verification between the control program versions shown in FIGS. 2 and 3 is applied when substituting the control programs in electronic equipment. Namely, in the first embodiment, the automatic compatibility verification method is applied after the unit is substituted, while, in this second embodiment, the method is applied when only the control program is substituted from external.

As shown in FIG. 5, in the printer 100 having the controller unit 2 and the mechanism the controller unit 3, the control program (CP) 22 in the controller unit 2 is substituted from the host 110 such as a personal computer and a dedicated tool by means of an installation tool 120.

In this case, when the control program (CP) 22 for the controller unit 2 is to be installed from the host 110, the version data of the control program (MP) 32, MP (M) and MP (c) in the mechanism controller unit 3 can be checked by the installer 120 by regarding unit 2 in the first embodiment as the host. Therefore, the compatibility verification system of the first embodiment is set in the installer 120, thereby the compatibility can be verified before installing a control program version newly for use.

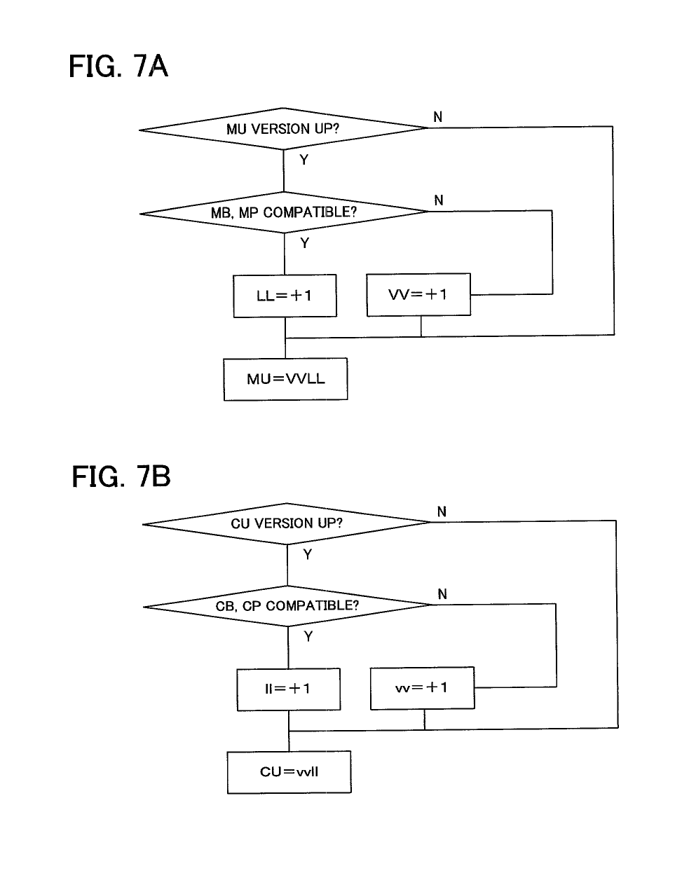

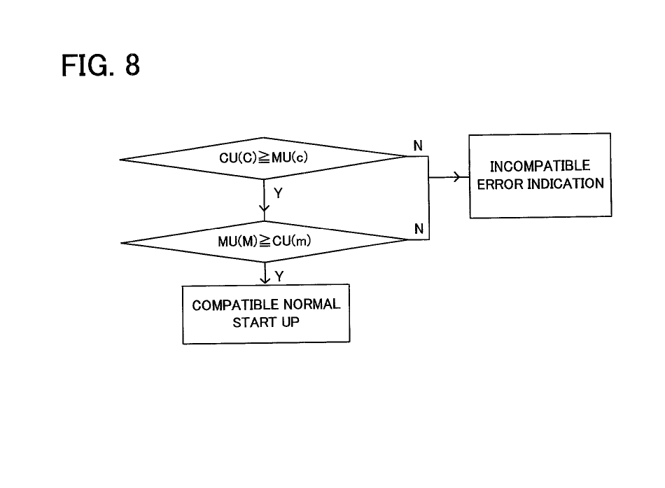

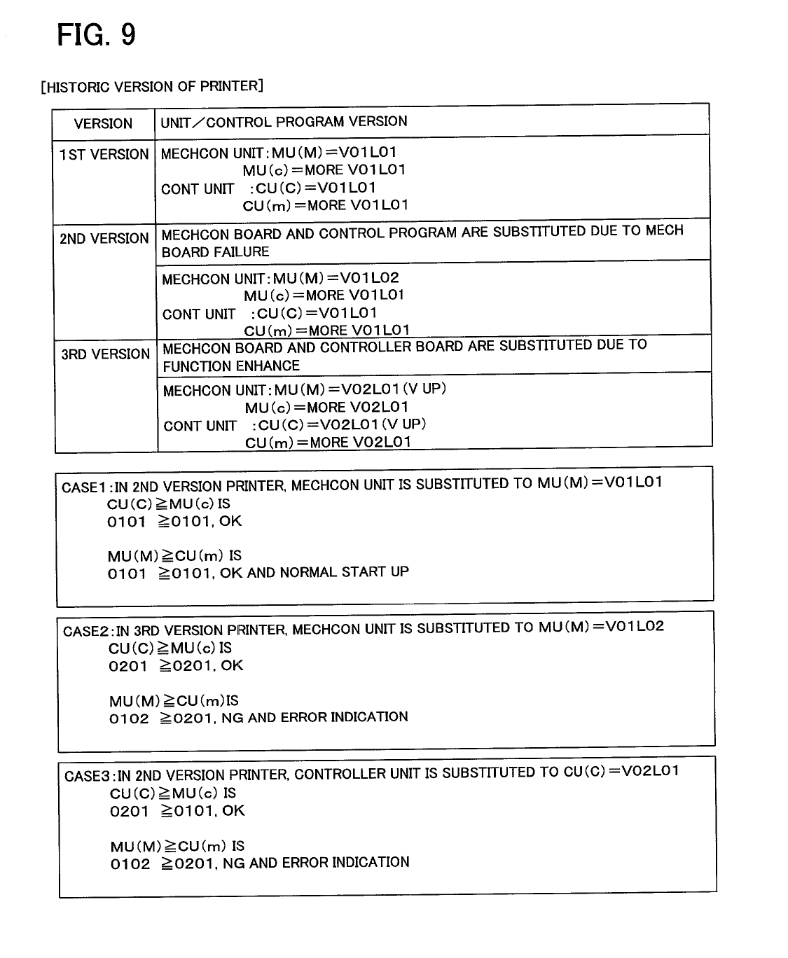

In FIGS. 6 to 9, there are shown explanation drawings of the compatibility verification method according to the third embodiment of the present invention. FIG. 6 shows version data. FIG. 7 shows definitions of the version data. FIG. 8 shows a flowchart of the compatibility verification processing. Also FIG. 9 shows typical examples.

In this embodiment, the automatic compatibility verification is carried out for the control boards in addition to the control programs. In the example shown in FIG. 1, the controller unit 2 is constituted by a control board CB, and the mechanism controller unit 3 is constituted by a control board MB. These control boards are configured with hardware including a processor, memory, etc. When substituting these elements, compatibility may not be maintained. Therefore the compatibility verification is also required for these control boards.

As shown in FIG. 6, version data set in both the control program (MP) 32 of the mechanism controller unit 3 and the control program (CP) 22 of the controller unit 2 are managed as portions of the version data of the respective units. Namely, in the control program (MP) 32 of the mechanism controller unit 3, the version data of both the control board MB and the control program MP are integrally managed using version data which is referred to as └MU┘.

Similarly, in the control program (CP) 22 of the controller unit 2, the version data of both the control board CB and the control program CP are integrally managed using version data which is referred to as └CU┘.

Here, the set version data MU contains a value ‘VVLL’, where ‘VV’ denotes a version part and ‘LL’ denotes an updated level part in the relevant version. The version updating corresponding to management version data MU is specified in FIG. 7A.

When the control board MB is upgraded, the management version data MU is updated. When updating MU, it is verified whether or not the new control board MB has compatibility with the present control program MP. If the compatibility is lost, control program MP is upgraded and the version part ‘VV’ of ‘VVLL’ in the management version data MU is updated. Namely, instead of updating the level part ‘LL’, the version part ‘VV’ is incremented by ‘1’.

On the other hand, if either the new control board MB has the compatibility with the present control program MP, or if only the control program MP is upgraded in the upgraded version MU without upgrading the control board MB itself, the level part ‘LL’ of ‘VVLL’ is updated. Namely, instead of updating the version part ‘VV’, the level part ‘LL’ is incremented by ‘1’.

Similarly, the management version data └CU┘ for the controller 2 contains a value ‘vvll’, where ‘vv’ denotes a version part and ‘ll’ denotes an updated level part in the version. The version updating in management version data CU is specified as shown in FIG. 7B.

When the control board CB is upgraded, the management version data CU is updated. On updating CU, it is verified whether or not new control board CB has compatibility with the present control program CP. If the compatibility is lost, the control program CP is upgraded and the version part ‘vv’ of ‘vvll’ in the management version data CU is updated. Namely, instead of updating the level part ‘ll’, the version part ‘vv’ is incremented by ‘1’.

On the other hand, if either the new control board CB has the compatibility with the present control program CP, or if only the control program CP is upgraded in the upgraded version CU without upgrading the control board CB, the level part ‘11’ of ‘vvll’ is updated. Namely, instead of updating the version part ‘vvll’, the level part ‘11’ is incremented by ‘1’. The CB and the CP are integrally managed by specifying the CU. As shown in FIG. 7, the version updating in management version data CU is also specified similarly to the above-mentioned MU.

In the control program (MP) 32, an MU version data MU (M) is provided, which contains a value ‘VVLL’ as shown in FIG. 6. Also, in the control program (MP) 32, a CU support version data MU (c), which is a support version data of the CU (opposite to the MU) supported by the MU, is provided. MU (c) contains a value ‘vvll’. As in the case of the aforementioned first embodiment, it is defined that the unit has the adjustment with the opposite unit when the opposite unit has a version data not smaller than ‘vvll’.

Similarly, in the control program (CP) 22, a CU version data CU (C) is provided, which contains a value ‘vvll’ as shown in FIG. 6. Also, in the control program (CP) 22, an MU (the opposite unit) support version data CU (m) supported by the CU is provided, which contains a value ‘VVLL’. If the unit has the version data not smaller than ‘VVLL’, it is defined that the unit has the adjustment with the opposite unit.

As shown in FIG. 8, after the version substitution of either the controller unit 2 or the mechanism controller unit 3, the compatibility verification is performed when starting up both the control programs 22 and 23. More specifically, the control program (CP) 22 in the controller unit 2 acquires the version data MU (M) and MU (c) in the control program (MP) 32 of the mechanism controller unit 3.

Next, the control program (CP) 22 in the controller unit 2 compares the own CU version data CU (C) with the acquired support MU version data MU (c). If CU (C) is not larger than MU (c), it is decided there is no compatibility, and an error is displayed on the operation panel 4. In other words, if the version data of CU board 2 is smaller (i.e. the version is older) than the CU version supportable by the mechanism controller unit 3, it is decided there is no compatibility, resulting in an error indication.

Similarly, the control program (CP) 22 in the controller unit 2 compares the own MU support version data CU (m) with the acquired MU version data MU (M). If MU (M) is not larger than CU (m) then it is decided there is no compatibility, and an error is displayed on the operation panel 4. In other words, if MU board 3 has a version older than the MU version supportable by controller unit 2, it is decided there is no compatibility, resulting in an error indication.

Otherwise, the above mentioned acquisition and verification may be carried out in the control program (MP) 32 in the mechanism controller unit 3. When the verification results in the existence of compatibility, it denotes that the controller unit as well as the control program has a larger version data than a version which the other controller unit and the controller expect. Accordingly the start up is performed normally. On the other hand, when the verification results in incompatibility, it denotes that either the controller unit or program in at least one controller does not have a larger version than a version which the other controller expects. Accordingly, an error indicating the incompatibility is displayed.

The above example illustrates the case of two units. The above method can be applied further in case of more than three units. By adding support version data for other units, it becomes possible to verify compatibility for more than three units (including both control board and control program).

Referring to FIG. 9, the above-mentioned method is explained more specifically. In FIG. 9, it is assumed that there exist three versions of printer, namely, a first, second and third version. Here, in the second version of the printer, a control board and a control program of the mechanism controller unit 3 of the first version is upgraded from ‘V01L01’to ‘V01L02’, having the compatibility with the control program (CP) 22 in the controller unit 2.

Also, in the third version, the printer of the first version is upgraded aiming at functional enhancement. The control board and the control program in the controller unit 2 and in the mechanism controller unit 3 are upgraded. Namely, the controller unit 2 is upgraded from ‘V01L01’ to ‘V02L01’, and the mechanism controller unit 3 of the second version is upgraded from ‘V01L02’ to ‘V02L01’.

Case 1: While the printer having the second version is used, in case that the mechanism controller unit 3 is substituted to MU (M)=‘V01L01’, the comparison of CU (C)≧MU (c) comes to 0101≧0101. This satisfies the compatibility. Also the comparison of MU (M)≧CU (m) becomes 0101≧0101. This also satisfies the compatibility. Accordingly the controller units are started up normally.

Case 2: While the printer having the third version is used, in case that the mechanism controller unit 3 is substituted to MU (M)=‘V01L02’, the comparison of CU (C)≧MU (c) becomes 0201≧0201. This satisfies the compatibility. However, MU (M)≧CU (m) becomes 0102≧0201, which is not true. Therefore the compatibility is not satisfied and an error is displayed.

Case 3: While the printer having the second version is used, in case that the controller unit 2 is substituted to CU (C)=‘V02L01’, the comparison of CU (C)≧MU (c) becomes 0201≧0101. This satisfies the compatibility. However, MU (M)≧CU (m) becomes 0102≧0201, which is not true. Therefore the compatibility is not satisfied and an error is displayed.

[Compatibility Verification Processing]

Hereafter, there is explained an example of the compatibility verification processing performed when switching on printer power, which includes automatic compatibility verification between control programs (i.e. mechanism controller firmware and controller firmware) after either a mechanism controller unit or a controller unit is substituted, and automatic version substitution when incompatibility is detected.

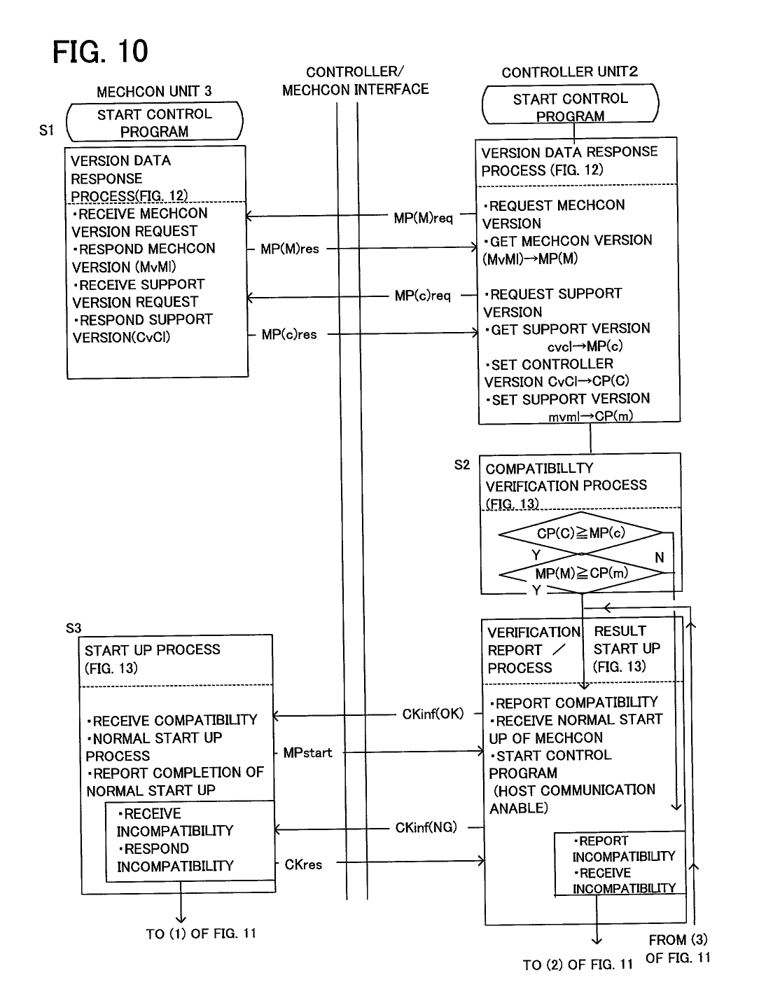

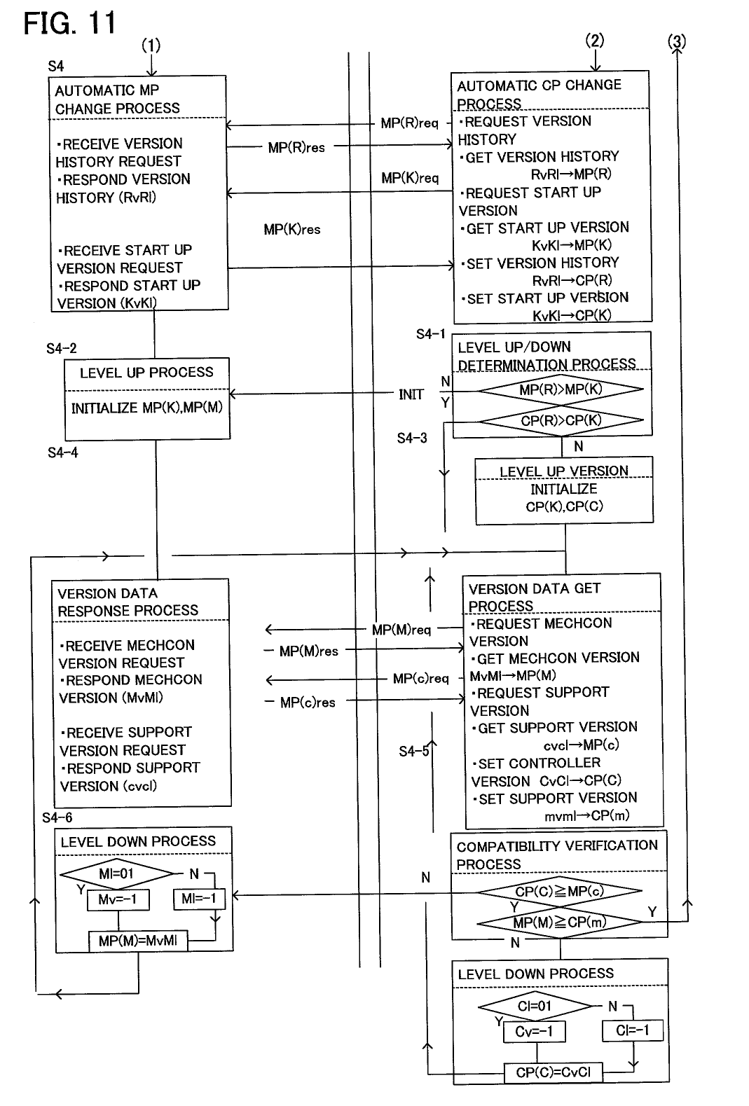

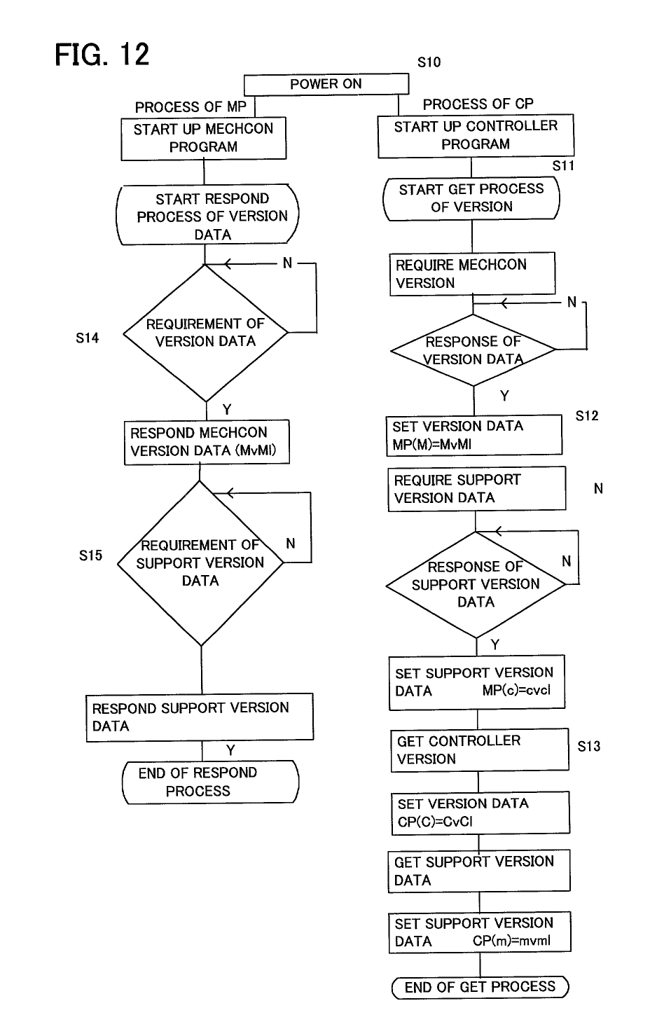

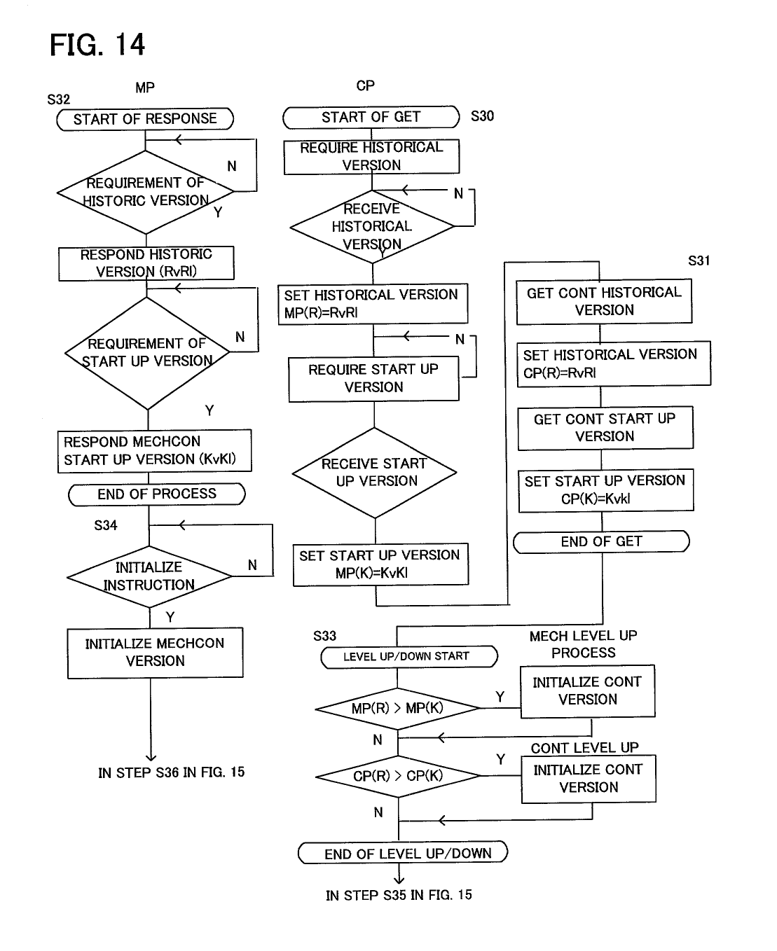

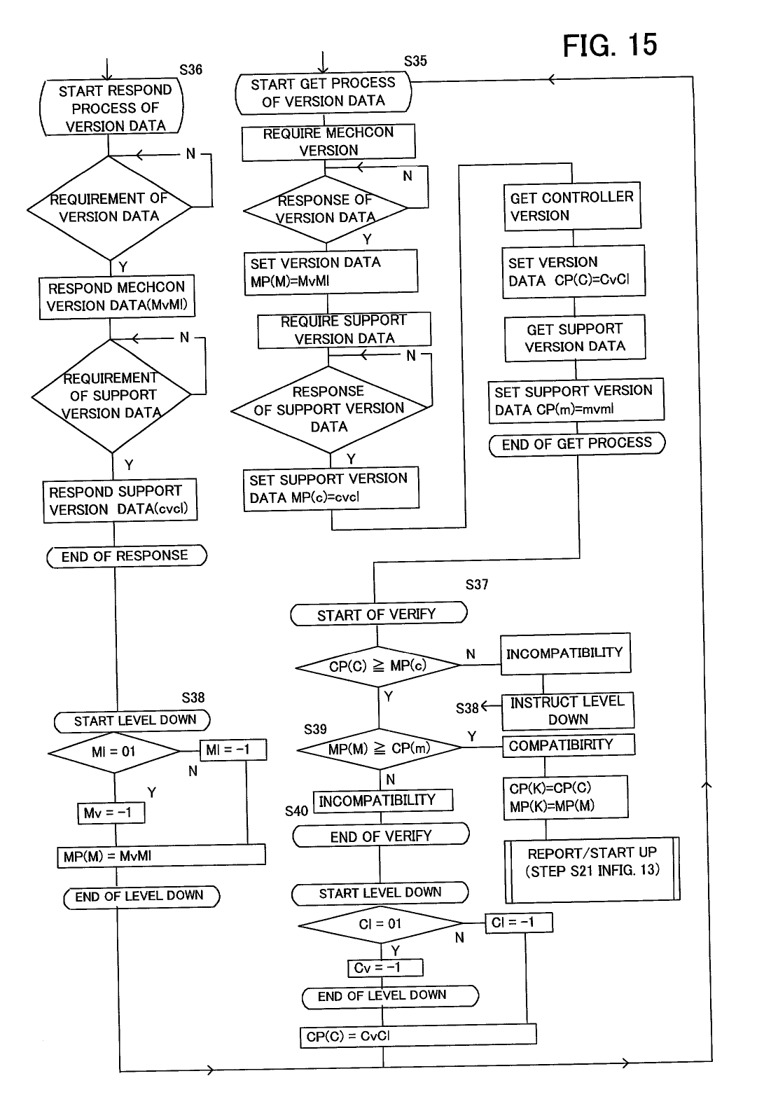

In FIGS. 10 and 11,there is shown an explanation drawing of the control sequence of the compatibility verification processing. In FIG. 12, there is shown a flowchart of a version data acquisition processing shown in FIG. 10. Also, in FIGS. 14 and 15, there is shown an automatic version substitution processing in case of the incompatibility is verified in FIG. 11.

Referring to FIGS. 10 and 11, a control sequence of the compatibility processing is explained. In this example, the controller unit 2 performs the compatibility verification processing and automatic version substitution processing in case the incompatibility is verifyed. It is also possible that the above-mentioned processing is carried out by the mechanism controller unit 3.

First, in the control program (CP) 22, a version data CP (C) (i.e. a version data of the control program (CP) 22 itself) is set ‘CvCl’, and a MP support version data CP (m) is set ‘mvml’. Similarly, in the control program (MP) 32, an MP version data MP (M) (i.e. a version data of the control program (MP) 32 itself), is set ‘MvMl’, and a CP support version data MP (c) is set ‘cvcl’.

(S1) When the printer power is switched on, the control programs in both the controller unit 2 and the mechanism controller unit 3 are started. The control program (CP) 22 then performs the version data acquisition processing (explained later using FIG. 12), and also the control program (MP) 32 performs the version data response processing (explained later also using FIG. 12). Through these processes, control program (CP) 22 of the controller unit 2 acquires the version data MP (M) and MP (c) of the control program (MP) 32 in the mechanism controller unit 3.

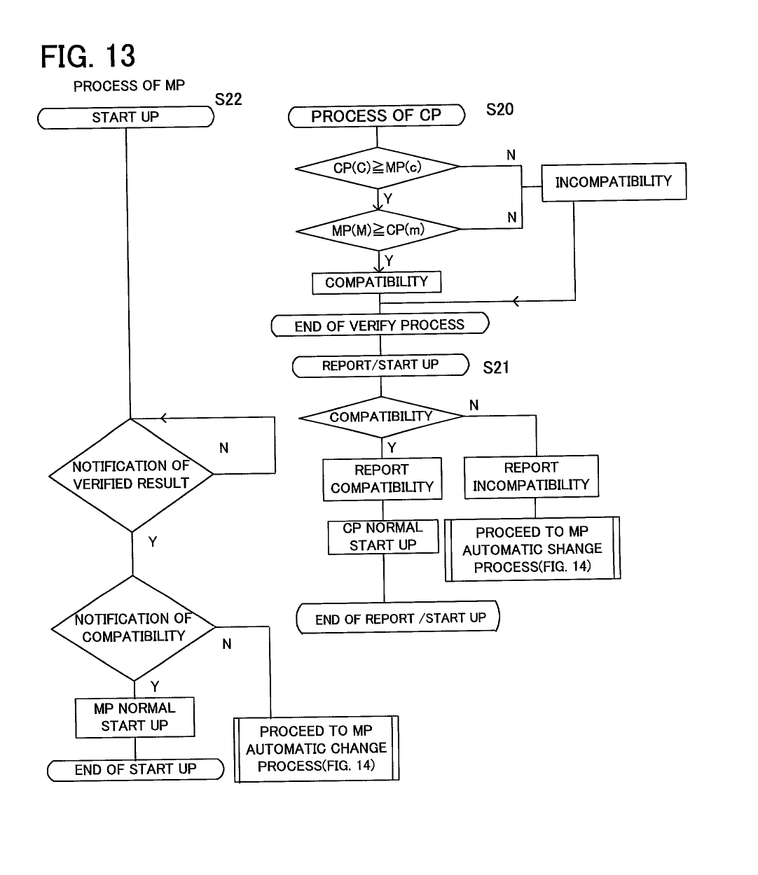

(S2) Next, the control program (CP) 22 in the controller unit 2 performs the compatibility verification processing (explained later using FIG. 13). As described before, the control program (CP) 22 in the controller unit 2 compares the own MP support version data CP (m) with the MP version data MP (M) having been acquired from the MP. If MP (M) is not larger than CP (m), it is decided there is no compatibility. Similarly, the control program (CP) 22 in the controller unit 2 compares the own CP version data CP (C) with the CP support version data MP (c) having been acquired from the MP. If CP (C) is not larger than MP (c), it is decided there is no compatibility.

(S3) After the completion of the compatibility verification processing, the control program (CP) 22 in the controller unit 2 performs the verification result report and startup processing. The control program (MP) 32 in the mechanism controller unit 3 performs the startup processing according to the verification result. In this startup processing, if the verification results in the control programs mutually having a version expected by the other and thus the compatibility is verified, normal startup procedure is carried out, as explained later using FIG. 13. On the other hand, if the verification results in the incompatibility, this incompatibility is reported and the process proceeds to step S4, in which automatic version substitution processing for the incompatibility case. More specifically, in the previous embodiment, on detection of the incompatibility, the process proceeds to the error processing. However, in this embodiment, when the incompatibility is detected, the versions of the control programs 22, 32 are automatically changed so that the compatibility can be maintained.

(S4) First, the control program (CP) 22 in the controller unit 2 acquires the historic versions of the control program (MP) 32 in the mechanism controller unit 3. It is then checked whether the control program in the mechanism controller unit 3 and the controller unit 2 is upgraded or downgraded (S4-1). If the above check finds the upgrading, an upgrade processing is carried out (S4-1, S4-2). The control program (CP) 22 in the controller unit 2 then acquires the version data of the control program (MP) 32 in the mechanism controller unit 3 (S4-3, S4-4). The control program (CP) 22 in the controller unit 2 performs the compatibility verification processing to verify the compatibility (S4-5). According to the result, the version downgrading processing is performed for the control program in either the mechanism controller unit 3 or the controller unit 2 (S4-5, S4-6). Steps S4-3 to S4-6 are repeated until the compatibility is obtained. This automatic version substitution processing is explained in more detail using FIGS. 14 to 20.

In such a manner, the control program in the controller unit 2 or the mechanism controller unit 3 is substituted. The compatibility is then verified when starting up both the control programs 22, 32. Thus, using the version data of one control program and the version data thereof being supported by the opposite control program, it is possible to decide the bi-directional compatibility between different versions of respective control programs. Accordingly, the operation can be guaranteed for substituting and installation of units each constituted by a control board and a control program having different versions from a control board and a control program in the opposite controller unit.

This extends the range of unit substitution. For example, units having the various versions can be substituted for the various versions of electronic equipment.

Also, when it is decided there is no compatibility after substituting or installing, it is possible to maintain compatibility by upgrading or downgrading control program automatically. This automatic version change enables to extend the substitution range between the units.

Now, each processing shown in FIG. 10 and FIG. 11 is explained hereafter. First, the version data acquisition processing in step S1 and in FIG. 10 is explained referring to FIG. 12.

(S10) In response to the power switched on, the control programs 22, 32 in both the controller unit 2 and the mechanism controller unit 3 are started.

(S11) The control program (CP) 22 starts the version data acquisition processing explained below: The control program (CP) 22 requests the control program (MP) 32 in the mechanism controller unit 3 to send the version data of the control program (MP) 32 (hereinafter referred to as ‘MP version data’). The control program (CP) 22 checks whether the response is received from the mechanism controller unit 3. If the response on the MP version data is received from the mechanism controller unit 3, the responded MP version data, ‘MvMl’, is set into MP (M).

(S12) Next, the control program (CP) 22 requests the control program (MP) 32 in the mechanism controller unit 3 to send the opposite controller version data supported by the mechanism controller (hereinafter referred to as ‘MP-supported CP support version data’). The control program (CP) 22 checks whether the response is received from the mechanism controller unit 3. If the response on the MP-supported CP support version data is received from the mechanism controller unit 3, the received MP-supported CP support version data, ‘cvcl’, is set into MP (c).

(S13) The control program (CP) 22 obtains the own CP version data ‘Cvcl’to set into CP (C) . Further, the control program (CP) 22 obtains the own CP-supported MP support version data, ‘mvml’, to set into CP (m). Thus the version data acquisition processing in the control program (CP) 22 is completed.

(S14) Meanwhile, the control program (MP) 32 in the mechanism controller unit 3 starts the version data response processing explained below: The control program (MP) 32 checks whether a request for sending the MP version data is received from the controller unit 2 (control program (CP) 22). If the request for the MP version data is received, the MP version data ‘MvMl’ is sent to the controller unit 2.

(S15) Next, the control program (MP) 32 checks whether a request for sending the MP-supported CP support version data is received from the controller unit 2. If the request of the MP-supported CP support version data is received, the MP-supported CP support version data, ‘cvcl’, is sent to the controller unit 2. Thus the version data response processing is completed.

Now, the compatibility verification processing step S2 and the startup processing step S3 respectively shown in FIG. 10 is explained in more detail referring to FIG. 13.

(S20) The control program (CP) 22 in the controller unit 2 starts the compatibility verification processing explained below: The control program (CP) 22 in the controller unit 2 compares the own CP version data CP (C) with the acquired MP-supported CP support version data (i.e. the CP support version data being supported by the mechanism controller) MP (c). If CP (C) is not larger than MP (c), it is decided there is no compatibility, and the compatibility verification processing is completed. In other words, if the version of the control program (CP) 22 is older than the version which can be supported by control program (MP) 32, there is no compatibility.

If CP (C) is greater than or equal to MP (c), the control program (CP) 22 in the controller unit 2 compares the own MP support version data CP (m) with the acquired MP version data MP (M). If MP (M) is not larger than CP (m), it is decided there is no compatibility between the CP and the MP, and the compatibility verification processing is completed. Namely, if the version of the control program (MP) 32 is a previous version which cannot be supported by controller unit 2, it is decided that there is no compatibility, to treat as an error. If MP (M) is greater than or equal to CP (m), it is decided there is compatibility and the compatibility verification processing is completed.

(S21) Next, the verification result report and startup processing is executed. When the compatibility is detected, this is reported to the mechanism controller unit 3. The control program 22 is then started up normally. Thus the verification result report and startup processing in the controller unit 2 is completed. On the other hand, when the incompatibility is detected, this is reported to the mechanism controller unit 3. Then the process goes to the automatic control program CP change processing when detecting incompatibility shown in FIG. 14.

(S22) Meanwhile, the control program (MP) 32 in the mechanism controller unit 3 starts the startup processing, and checks whether the verification result report is received from the controller unit 2. If the verification result report is received, it is checked whether the compatibility is reported. When it is reported there is the compatibility, the control program (MP) 32 is started up normally and thus the startup processing in the mechanism controller unit 3 is completed. When it is reported there is no compatibility, then the process goes to the automatic control program MP change processing when detecting incompatibility shown in FIG. 14.

Next, the automatic CP/MP change processing when detecting incompatibility is explained referring to FIGS. 14 and 15.

(S30) The control program (CP) 22 then starts the version data acquisition processing explained below: The control program (CP) 22 requests the control program (MP) 32 in the mechanism controller unit 3 to send a historic version record of the mechanism controller unit 3. The historic version record of mechanism controller unit 3 shows the history of the control programs (MP) 32 which were installed in the mechanism controller unit 3. For example, assuming the current version data of the control program (MP) 32, or MP (M), is ‘V02L01’, then historic version record MP (R) of the control program (MP) 32 may include ‘V01L02’ and ‘V01L01’. The control program 22 checks a response for the historic version record request, and when the response of the historic version record is received from the mechanism controller unit 3, the responded historic version record of the MP version data ‘RvRl’ is set into MP (R).

Next, the control program (CP) 22 requests the control program (MP) 32 in the mechanism controller unit 3 to send an internal startup version data of the control program (MP) 32. The control program (CP) 22 then checks whether a response on the internal startup version data is received from the mechanism controller unit 3. When the internal startup version data of the control program (MP) 32 is received from the mechanism controller unit 3, the replied ‘KvKl’ is set into MP (K).

(S31) The control program (CP) 22 obtains a historic version record of the own controller, ‘RvRl’, and sets into CP (R). Further, the control program (CP) 22 obtains an internal startup version data ‘KvKl’ and sets into CP (K). Thus the version data acquisition processing in the control program (CP) 22 is completed.

(S32) Meanwhile, the control program (MP) 32 in the mechanism controller unit 3 starts a version data response processing explained below: The control program (MP) 32 checks whether a historic version record of the control program (MP) 32 is requested from the controller unit 2. When the historic version record request is received from the controller unit 2, the historic version record of the control program (MP) 32, ‘RvRl’, is replied to the controller unit 2. The control program (MP) 32 then checks whether an internal startup version data of the control program (MP) 32 is requested from the controller unit 2. When the request for internal startup version data of the control program (MP) 32 is received from the controller unit 2, the internal startup version data of the control program (MP) 32, ‘KvKl’, is replied to the controller unit 2. Thus the version data response processing in the control program (MP) 32 is completed.

(S33) Next, the control program (CP) 22 in the controller unit 2 starts a version upgrading/downgrading determination processing shown in step S4-1 of FIG. 11 explained below: The acquired historic version record of the control program (MP) 32, MP (R), is compared with the internal startup version data of the control program (MP) 32, MP (K). If MP (K) is smaller than MP (R), an initialization of the MP version data is ordered to the mechanism controller unit 3 so as to decide whether or not the upgrading of the control program (MP) 32 is possible.

On the other hand, if MP (R) is smaller than MP (K), the control program (CP) 22 in the controller unit 2 compares the own historic version record CP (R) with the own internal startup version data CP (K). If CP (K) is smaller than CP (R), the CP version data is initialized so as to decide whether or not the upgrading of the control program (CP) 22 is possible. Thus the version upgrading/downgrading determination processing is completed.

(S34) Meanwhile, the control program (MP) 32 in the mechanism controller unit 3 checks whether the initialization instruction is received from the controller unit 2. If the initialization instruction is received, the control program (MP) 32 initializes the MP version data.

(S35) Next, the process proceeds to FIG. 15 in which the control program (CP) 22 starts the version data acquisition processing explained below: The control program (CP) 22 requests the control program (MP) 32 in the mechanism controller unit 3 to send the MP version data. The control program (CP) 22 checks whether a response for the version data request on the mechanism controller unit 3 is received from the mechanism controller unit 3. If the response for the MP version data request is received, the responded MP version data, ‘MvMl’, is set into MP (M).

Next, the control program (CP) 22 requests the control program (MP) 32 in the mechanism controller unit 3 to send the MP-supported CP support version data. The control program (CP) 22 checks whether a response for the MP-supported CP support version data is received from the mechanism controller unit 3. If the response for the MP-supported CP support version data is received, the responded MP-supported CP support version data ‘cvcl’ is set into MP (c).

The control program (CP) 22 obtains the own CP version data ‘CvCl’ and sets into CP (C). Further, the control program (CP) 22 obtains the own CP-supported MP support version data ‘mvml’ and sets into CP (m). Thus the version data acquisition processing in the control program (CP) 22 is completed.

(S36) Meanwhile, the control program (MP) 32 in the mechanism controller unit 3 starts the version data response processing explained below: The control program (MP) 32 checks whether a request for sending the MP version data is received from the controller unit 2 (control program (CP) 22). If the request for the MP version data is received, the MP version data ‘MvMl’ is sent to the controller unit 2. Next, the control program (MP) 32 checks whether a request for sending the MP-supported CP support version data is received from the controller unit 2. If the request of the MP-supported CP support version data is received, the MP-supported CP support version data, ‘cvcl’, is sent to the controller unit 2. Thus the version data response processing is completed.

(S37) Next, the control program (CP) 22 in the controller unit 2 starts the compatibility verification processing explained below: The control program (CP) 22 in the controller unit 2 compares the own CP version data CP (C) with the acquired MP-supported CP support version data MP (c). If CP (C) is not greater than MP (c), the control program (CP) 22 decides there is no compatibility, and instructs the mechanism controller unit 3 to downgrade the version of the control program (MP) 32. In other words, if the version of the control program (CP) 22 is older than the version which can be supported by the control program (MP) 32, the control program (CP) 22 decides there is no compatibility, and orders the mechanism controller unit 3 to downgrade the version of the control program (MP) 32 in the mechanism controller unit 3.

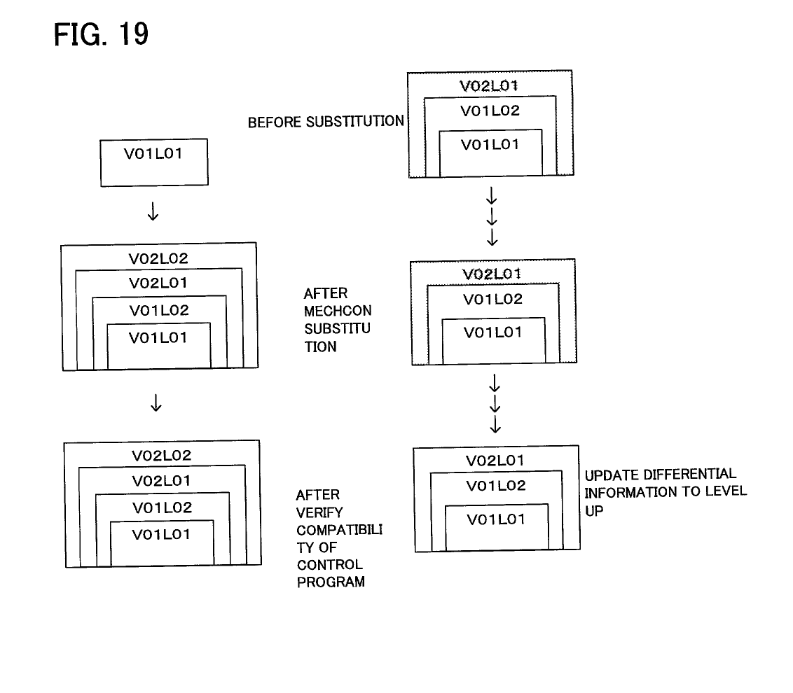

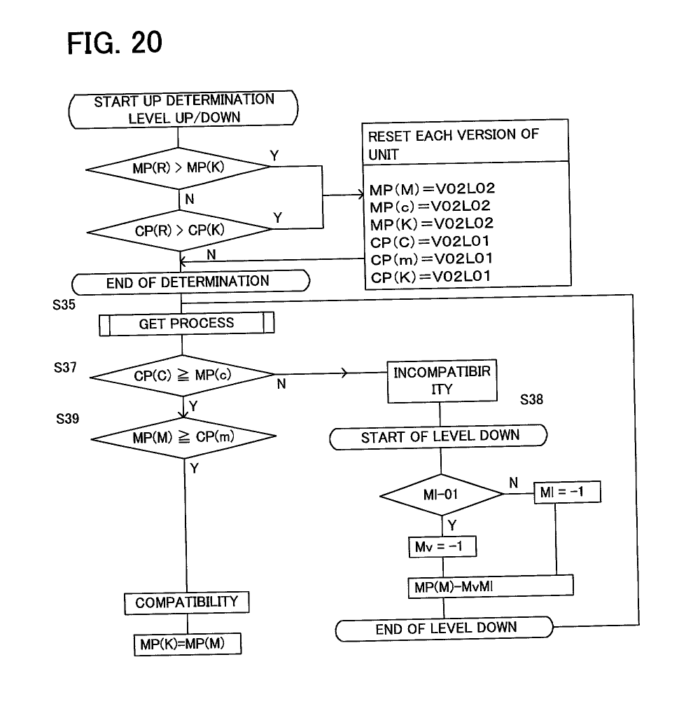

(S38) Now, on receiving the order of downgrading the version, the control program (MP) 32 in the mechanism the controller unit 3 decides whether the ‘Ml’ in MP version data ‘MvMl’ is ‘01’. If ‘Ml’ is ‘01’, the ‘Mv’ is decremented by ‘1’. Else if ‘Ml’ is not ‘01’, then the ‘Ml’ is decremented by ‘1’. In such a manner, MP (M)=MvMl is downgraded. Then the completion of the version downgrading processing of the control program (MP) 32 is reported to the controller unit 2. This version downgrading processing of the control program (MP) 32 is explained later in more detail using FIGS. 19 and 20.

(S39) If CP (C) is greater than or equal to MP (c), the control program (CP) 22 in the controller unit 2 compares the own MP support version data CP (m) with the acquired MP version data MP (M). If MP (M) is not greater than CP (m), it is decided there is no compatibility. Thus the compatibility verification processing is completed, and the process proceeds to the controller version downgrading processing, shown in the step S40 below. Namely, if the version of the control program (MP) 32 is a previous version which cannot be supported by the controller unit 2, it is decided that there is no compatibility, and the process proceeds to the version downgrading processing. If MP (M) is greater than or equal to CP (m), it is decided there is the compatibility, and the compatibility verification processing is completed.

Next, the updated CP version data CP (C) is set into the CP startup version data CP (K), and also the updated MP version data MP (M) is set into the MP startup version data MP (K). Thus the startup version data is updated. Then the process proceeds to verification result report and startup processing similar to the step S21 shown in FIG. 13. Namely, when the compatibility is detected, this is reported to the mechanism controller unit 3. The control program 2 is then started up normally, and the verification result report and startup processing in the controller unit 2 is completed. Meanwhile, the control program (MP) 32 in the mechanism controller unit 3 starts the startup processing. On receiving from the controller unit 2 the verification result report indicating there is the compatibility, the control program (MP) 32 is started up normally and thus the startup processing in the mechanism controller unit 3 is completed.

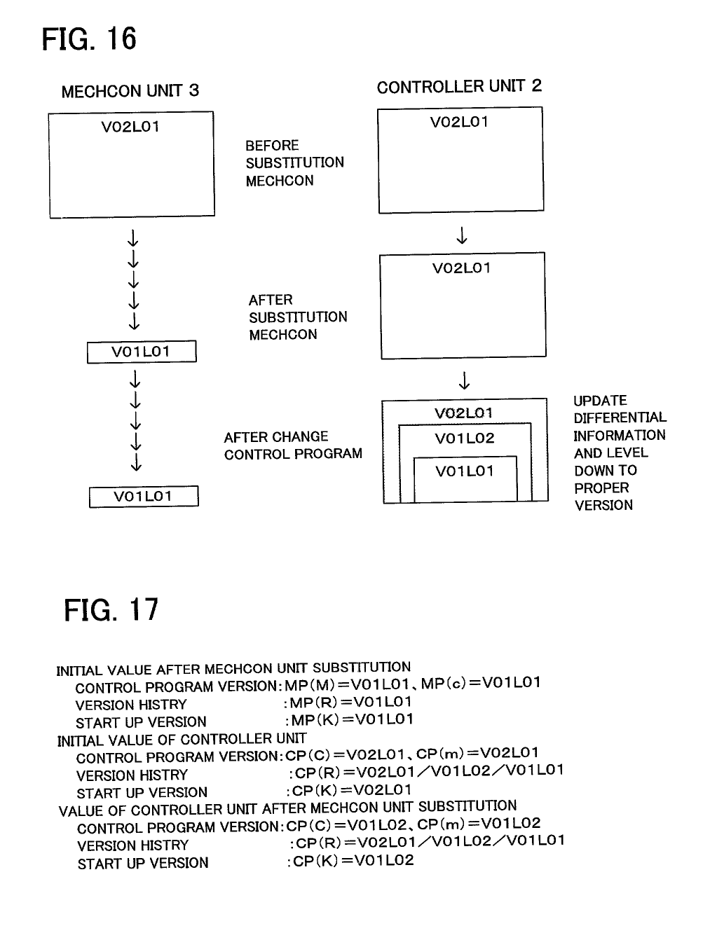

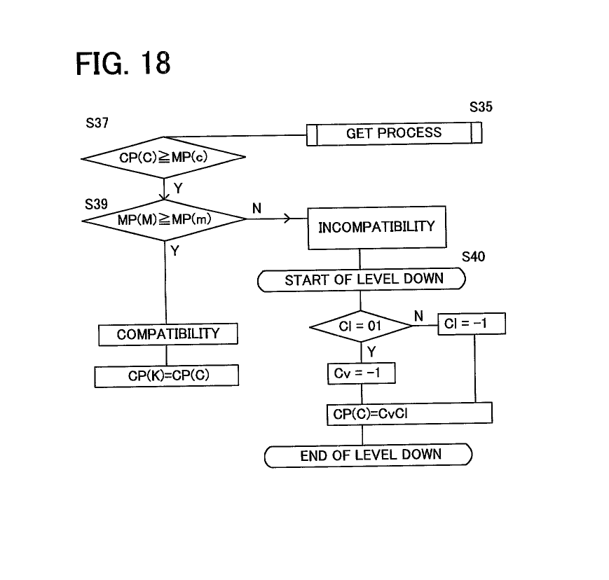

(S40) Next, the control program (CP) 22 starts the version downgrading processing to decide whether the ‘Cl’ in the CP version data ‘CvCl’ is equal to ‘01’. If ‘Cl’ is ‘01’, the ‘Cv’ is decremented by ‘1’. Else if ‘Cl’ is not ‘01’, then the ‘Cl’ is decremented by ‘1’. In such a manner, CP (C)=CvCl is downgraded. Then the process returns to step S35. This controller version downgrading processing is explained later in more detail using FIGS. 16 and 18.

In such a manner, the internal startup version data is compared with the version data in the historic version record. When the internal startup version data is smaller than a version data in the historic version record, version data of each control program is reset to the initial value so as to check whether the upgrading of the control program is possible. After the version data is reset to the initial value, the version data of each control program is acquired so as to verify the compatibility therebetween. If it is decided there is incompatibility, the version of either the control program in the controller unit or the control program in the mechanism controller unit is downgraded by one, and the compatibility verification is repeated.

If incompatibility is still detected, the version of the control program is further downgraded, to repeat the compatibility verification. If compatibility is detected now, the updated control program version is set into the respective internal startup version data, CP (K) or MP (K). Here, by configuring each newer version of the control program with an older version of the control program and differential information (between the newer and the older versions of the control program), it becomes possible to update the control program for use automatically by making the differential information valid. Thus, the control program can be shifted (either upgraded or downgraded) to the control program having the most appropriate version, to be started up normally with the compatibility maintained.

Now, referring to FIGS. 16 to 18, the controller version downgrading operation is described hereafter. As shown in FIG. 16, when the control program (MP) 32 in the mechanism control unit 3 is substituted from ‘V02L01’ to ‘V01L01’, the initial values in the mechanism control unit 3 after the version substitution become the following, as illustrated in FIG. 17.

Control program version data:

MP (M)=V01L01, MP (c)=V01L01

Historic versions: MP (R)=V01L01

Internal startup version data: MP (K)=V01L01

In case of FIG. 16, the initial values in the control unit 2 before the version substitution in the mechanism controller unit 3 is shown in the following, as illustrated in FIG. 17.

Control program version data:

CP (C)=V02L01, CP (m)=V02L01

Historic versions: CP (R)=V02L01/V01L02/V01L01

Internal startup version data: CP (K)=V02L01

In this condition, in the case of FIG. 16, when the controller version downgrading processing, i.e. steps S39 and S40, is carried out as shown in FIG. 18 (a partial flow of FIG. 15), the values in the control unit 2 after the automatic version change in the mechanism control unit 3 become the following, as shown in FIG. 17.

Control program version data:

CP (C)=V01L02, CP (m)=V01L02

Historic versions: CP (R)=V02L01/V01L02/V01L01

Internal startup version data: CP (K)=V01L02

That is, as shown in FIG. 16, the control program (CP) 22 is downgraded from ‘V02L01’ to ‘V01L02’ so as to have the compatibility with the substituted control program (MP) 32. Here, as shown in FIG. 16, the program having a version ‘V01L02’ is constituted by the program having the version ‘V01L01’ and the differential information, and also the program having the version ‘V02L01’ is constituted by the program having the version ‘V01L02’ and the differential information thereof. Accordingly, the program having the version ‘V02L01’ can be shifted to the program having the version ‘V01L02’ by making the corresponding differential information invalid.

Now, referring to FIGS. 19 to 20, the controller version upgrading operation is described hereafter. As shown in FIG. 19, when the control program (MP) 32 in the mechanism control unit 3 is substituted from ‘V01L01’ to ‘V02L02’, the initial values in the mechanism control unit 3 after the version substitution become the following.

Control program version data:

MP (M)=V02L02, MP (c)=V02L02

Historic versions: MP (R)=V02L02/V02L01/V01L02/ V01L01

Internal startup version data: MP (K)=V02L02

In case of FIG. 19, the initial values in the control unit 2 before the version substitution of the mechanism controller unit 3 is shown in the following.

Control program version data:

CP (C)=V01L02, CP (m)=V01L01

Historic versions: CP (R)=V02L01/V01L02/V01L01

Internal startup version data: CP (K)=V01L02

In this condition, in the case of FIG. 19, when the controller version upgrading processing, i.e. steps S33, S37 and S38, is carried out as shown in FIG. 20 (a partial flow of FIG. 15), the values in the control unit 2 after the automatic version change of the mechanism control unit 3 become the following.

Control program version data:

CP (C)=V02L01, CP (m)=V02L01

Historic versions: CP (R)=V02L01/V01L02/V01L01

Internal startup version data: CP (K)=V02L01

That is, as shown in FIG. 19, the control program (CP) 22 is upgraded from ‘V01L02’ to ‘V02L01’ so as to have the compatibility with the substituted control program (MP) 32. Also in this case, as shown in FIG. 16, the program having a version ‘V01L02’ is constituted by the program having the version ‘V01L01’ and the differential information, and also the program having the version ‘V02L01’ is constituted by the program having the version ‘V01L02’ and the differential information. Accordingly, the program having the version ‘V01L02’ can be shifted to the program having the version ‘V02L01’ by making the corresponding differential information valid.

[Other embodiment]

According to the embodiments described above, the automatic version change processing shown in FIGS. 14 and 15 is performed based on the version compatibility verification processing shown in FIG. 13. However, this automatic version change processing may be applied to the case in which the result of the version compatibility verification step is not used.

The effects of the present invention are summarized below. According to the present invention, there are provided in each unit by unit the own version data and the support version data of the opposite controller unit side. Using these data, the version data related to each unit are checked in either one unit. Therefore, when one unit fails and a unit having a newer (or older) version is incorrectly substituted for the failed unit, thus resulting in loss of compatibility, the compatibility verification can be carried out automatically between any combinations of the units having different versions. In addition, because the automatic version adjustment between the units is included, the version of a unit can be shifted to the optimal version of the unit which can maintain the compatibility. Thus normal startup of the controller units is enabled.

The foregoing description of the embodiments is not intended to limit the invention to the particular details of the examples illustrated. Any suitable modification and equivalents may be resorted to the scope of the invention. All features and advantages of the invention which fall within the scope of the invention are covered by the appended claims.

What is claimed is:

1. Electronic equipment having a plurality of electronic units working in cooperation comprising:
a first electronic unit having a first version data of said first electronic unit itself, and first support version data of an opposite second electronic unit being supported by said first electronic unit; and
the second electronic unit having a second version data of said second electronic unit itself, and a second support version data of the opposite first electronic unit being supported by said second electronic unit,
wherein at least either one of said first electronic unit and said second electronic unit compares the magnitude of said first version data and said second support version data, compares the magnitude of said second version data and said first support version data and verifies the compatibility between said plurality of electronic units from a great and small relationship according to both compared results.

2. The electronic equipment according to claim 1 wherein said each plurality of electronic units comprises:
a memory for storing control program; and
a processor for executing said control program,
and wherein said version data comprises the version data of said control program.

3. The electronic equipment according to claim 1 wherein said either one electronic unit verifies the compatibility after either electronic unit of said first electronic unit or said second electronic unit is substituted.

4. The electronic equipment according to claim 1 wherein said first and second support version data comprises a newest support version data.

5. The electronic equipment according to claim 1 wherein said plurality of electronic units are constituted by printer controller units.

6. The electronic equipment according to claim 2 wherein said either one electronic unit changes said version of the control program when verified as incompatibility to automatically shift a proper version having the compatibility.

7. The electronic equipment according to claim 6 wherein said either one electronic unit controls a valid or invalid of a difference information in the control program comprised an old control program and said difference information between the old control program to change said version of said control program.

8. The electronic equipment according to claim 6 wherein each of said plurality of electronic units comprises:
a memory for storing control program; and
a processor for executing said control program,
wherein said either one electronic unit verifies the compatibility using said version data of said control programs after said control program version is changed to maintain the compatibility between said control programs.

9. The electronic equipment according to claim 2 wherein said either one electronic unit verifies the compatibility when installing said control program of either one electronic unit.

10. An electronic unit working in cooperation with the opposite electronic unit, said electronic unit having compatibility verification data for verifying the compatibility with said opposite electronic unit, said compatibility verification data comprising:
a support version data of said opposite electronic unit being supported by said electronic unit itself, to be compared with a version data of said opposite electronic unit; and
a version data of said electronic unit itself being supported by said opposite electronic unit.

11. A method for verifying the compatibility in electronic equipment having a plurality of electronic units working in cooperation, said method comprising the steps of:
comparing a first version data of one electronic unit among said plurality of electronic units with a second support version data of said electronic unit being supported by another electronic unit;
comparing a second version data of the other electronic unit with a first support version data of the other electronic unit being supported by said electronic unit; and
verifying the compatibility among said plurality of electronic units using said compared results.

12. The method for verifying the compatibility according to claim 11 wherein said first and support version data comprises the version data of a control program of said one electronic unit, and
said second and support version data comprises version data of a control program of said other electronic unit.

13. The method for verifying the compatibility according to claim 11 wherein said compatibility verification is performed after either one electronic unit of said first electronic unit or said second electronic unit is substituted.

14. The method for verifying the compatibility according to claim 11 wherein said first and second support version data comprises a newest support version data.

15. The method for verifying the compatibility according to claim 11 wherein said plurality of electronic units are constituted by printer controller units.

16. The method for verifying the compatibility according to claim 12, further comprising a step of changing said version of the control program when verified as incompatibility to automatically shift a proper version having the compatibility.

17. The method for verifying the compatibility according to claim 12 wherein said compatibility verification is performed on installing a control program of either one of the plurality of electronic units.

18. The method for verifying the compatibility in electronic equipment according to claim 16 further comprising the step of:
re-verifying the compatibility using said version data of said control programs after changing a version of said control program to be executed by a processor in said electronic unit.

19. The method for verifying the compatibility according to claim 17 wherein said changing step comprises a step of changing a version of said control program being constituted by an older version of said control program and differential information between said versions, by controlling to make said differential information either valid or invalid.
